(19) United States
(12) Patent Application Publication
(10) Pub. No.: US 2002/0188064 A1
(43) Pub. Date: Dec. 12, 2002

(54) Centipede ionomers

(75) Inventors: Xiaorong Wang, Hudson, OH (US); Victor J. Foltz, Akron, OH (US)

Correspondence Address: Chief Intellectual Property Counsel, Bridgestone/Firestone, Inc., 1200 Firestone Parkway, Akron, OH, 44317-0001, US

(73) Assignee: Bridgestone/Firestone Research, Inc.

(21) Appl. No.: 09/862,944

(22) Filed: May 22, 2001

(51) Int. Cl. C08G 63/48

(52) U.S. Cl. 525/66; 524/262; 524/474; 524/484; 524/534; 525/64; 525/70; 525/73; 525/78; 525/242; 525/327.6; 528/310

(57) ABSTRACT

The present invention is directed to a polymeric composition including a poly(alkenyl-co-maleimide) and an inorganic salt. Optionally, an extender is included. The composition exhibits good strength and vibration damping properties.

### BACKGROUND OF THE INVENTION

Two or more polymers may be blended together to form a wide variety of random or structured morphologies that can be used to provide products with potentially desirable combinations of characteristics. However, it may be difficult or even impossible in practice to achieve many potential combinations through simple blending because of some inherent and fundamental problems. Frequently, the polymers are thermodynamically immiscible, which precludes generating a truly homogeneous product. While immiscibility may not be a problem since it may be desirable to have a two-phase structure, the situation at the interface between these two phases very often leads to problems. The typical case is one of high interfacial tension and poor adhesion between the two phases. This interfacial tension contributes, along with high viscosities, to the inherent difficulty of imparting the desired degree of dispersion to random mixtures and to their subsequent lack of stability, giving rise to gross separation or stratification during later processing or use. Poor adhesion leads, in part, to the very weak and brittle mechanical behavior often observed in dispersed blends and may render some highly structured morphologies impossible.

Ionic polymers, or ionomers, are polymers with inorganic salt groups attached to the polymer chain. They have a low ionic content and low polarity backbone. The most common ionomers are formed by the neutralization of ethylene copolymers containing up to 5-10% (meth)acrylic copolymer with a metal salt such as the acetate or oxide of Zn, Na, Mg, Ba, B, Co, or Al. These ionomers can act like reversibly crosslinked thermoplastics as a result of microphase separation between ionic metal carboxylate and nonpolar hydrocarbon segments. The behavior is similar to physical crosslinking in thermoplastic elastomers.

Polypropylene grafted centipede polymers have been developed to overcome the above-mentioned difficulties. These grafted polymers may be formed by grafting polypropylene chains onto partially imidized poly(alkenyl-co-maleimide) chains. The polypropylene chains react with a remaining percentage of maleic anhydride units to form polypropylene grafted poly(alkenyl-co-maleimide). These grafted polymers demonstrate improved compatibility when blended with other polymers to provide a variety of random or structured morphologies. However, the polypropylene grafting step adds manufacturing complexity and extra cost to the overall process.

Providing a centipede polymer composition which is relatively thermally stable, exhibits high damping properties, and can be prepared in a commercially viable manner remains desirable as an alternative to the extra manufacturing steps of polypropylene grafting.

### SUMMARY OF THE INVENTION

According to an exemplary embodiment, the present invention is directed to a polymeric composition including a poly(alkenyl-co-maleimide) and an inorganic salt, and sometimes is referred to herein as “ionomeric”. Optionally, an extender is included in the composition.

According to a further embodiment of the present invention, a process for forming an ionomeric polymer by reacting a poly(alkenyl-co-maleimide) with an inorganic salt and, optionally, an extender is provided.

According to an additional embodiment, a polymeric composition comprising an extended centipede polymer is provided. The centipede polymer includes alkenyl units, maleimide units of maleic anhydride and primary amine, and a minority of ionomeric units of maleic anhydride and ionic salt. The polymeric composition demonstrates a tan δ of above about 0.4 at 25° C.

The following definitions apply hereinthroughout unless a contrary intention is expressly indicated:

“centipede polymer” refers to polymer compositions of poly(alkenyl-co-maleimide);

“poly(alkenyl-co-maleimide)” includes poly(alkenylbenzene-co-maleimide), poly(R¹R² ethylene-co-maleimide), and poly(alkyl vinyl ether-co-maleimide);

“vinyl aromatic hydrocarbon” and “alkenyl benzene” are used interchangeably;

“maleic anhydride” encompasses dicarboxylic acids, including maleic anhydride, which can form a copolymer with an alkenyl benzene, an R¹R² ethylene, or an alkyl vinylether, the copolymer having dicarboxylic acid units which are capable of reaction with an amine functional group;

“maleimide” encompasses the reaction product of an amine and the dicarboxylic acids described above; and

“R¹R² ethylene” encompasses compounds of the general formula:

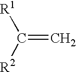

where R¹ and R² are the same or different substituents on the same or different carbon atoms of the ethylene group, and are independently H or substituted C₁-C₂₀ alkyl groups.

### DETAILED DESCRIPTION OF ILLUSTRATIVE EMBODIMENTS

The polymer composition utilizes centipede polymers including poly(alkenyl-co-maleimide), inorganic salts, and optionally, an extender. The centipede polymer is formed by imidizing a poly(alkenyl-co-maleic anhydride) with a mono-primary amine. The centipede polymer has a high molecular weight spine and many relatively short side chains formed from addition of the mono-primary amines. The main chain usually is at least as long as the entanglement length, which is herein defined theoretically as an order of magnitude of 100 repeating units, while the length of the side chains is less than the entanglement length.

Poly(alkenyl-co-maleimide) and poly(alkenyl-co-maleic anhydride) encompass random and stereospecific copolymers, including copolymers having alternating alkenyl-contributed units (i.e., monomer units derived from an alkenyl benzene such as styrene) and maleimide- or maleic anhydride-contributed units (i.e., monomer units derived from a maleimide or maleic anhydride) along the polymer backbone. Such alternating structures typically are described as poly(alkenyl-alt-maleimide) and poly(alkenyl-alt-maleic anhydride); however, these polymers are encompassed in the terms poly(alkenyl-co-maleimide) and poly(alkenyl-co-maleic anhydride).

The alkenyl monomer contributed units of the poly(alkenyl-co-maleimide) are preferably alkenyl benzene, R¹R² ethylenes, alkyl vinyl ethers, and mixtures thereof

Preferred alkenyl benzene contributed monomer units of the poly(alkenyl benzene-co-maleimide) centipede preferably are derived from one or more of styrene, α-methylstyrene, 1-vinyl naphthalene, 2-vinyl naphthalene, 1-α-methyl vinyl naphthalene, 2-α-methyl naphthalene, as well as alkyl, cycloalkyl, aryl, alkaryl, and aralkyl derivatives thereof, in which the total number of carbon atoms in the combined hydrocarbon is generally not greater than 18, as well as di-or tri-vinyl-substituted aromatic hydrocarbons. Preferred vinyl-substituted aromatic hydrocarbons are styrene and a-methylstyrene.

The R¹ and R² constituents of the R¹R² ethylene contributed monomer units and the alkyl constituents of the alkyl vinyl ether contributed monomer units are independently selected from one or more of methyl, ethyl, propyl, isopropyl, butyl, isobutyl, pentyl, isopentyl, hexyl, heptyl, octyl, nonyl, decyl, undecyl, dodecyl, tredecyl, tetradecyl, pentadecyl, hexadecyl, heptadecyl, octadecyl, nonadecyl, eicosyl, cyclopropyl, 2,2-demethylcyclopropyl, cyclopentyl, cyclohexyl, methoxymethyl, methoxyethyl, methoxypropyl, methoxybutyl, methoxypentyl, methoxyhexyl, methoxyoctyl, methoxynonyl, ethoxydecyl, ethoxymethyl, ethoxyethyl, ethoxypropyl, ethoxybytyl, ethoxypentyl, ethoxyhexyl, ethoxyheptyl, ethoxyoctyl, ethoxynonyl, ethoxydecyl, propoxymethyl, propoxyethyl, propoxypropyl, propoxybutyl, propoxypentyl, propoxyheptyl, propoxyoctyl, propoxynonyl, propoxydecyl, butoxymethyl, butoxyethyl, butoxypropoyl, butoxybutyl, butoxypentyl, butoxyhexyl, butoxyheptyl, butoxyoctyl, butoxynonyl, butoxydecyl, pentyloxymethyl, pentyloxyethyl, pentyloxypropyl, pentyloxybutyl, pentyloxypentyl, pentyloxyhexyl, pentyloxyoctyl, pentyloxynonyl, pentyloxydecyl, hexyloxymethyl, hexyloxyethyl, hexyloxypropyl, hexyloxybutyl, hexyloxypentyl, hexyloxyhexyl, hexyloxyheptyl, hexyloxyoctyl, hexyloxynonyl, hexyloxydecyl, heptyloxymethyl, heptyloxyethyl, heptyloxypropyl, heptyloxybutyl, hexyloxypentyl, heptyloxyhexyl, heptyloxyheptyl, heptyloxyoctyl, heptyloxynonyl, heptyloxydecyl, octyloxymethyl, octyloxyethyl, octyloxypropyl, octyloxybutyl, octyloxypentyl, octyloxyhexyl, octyloxyheptyl, octyloxyoctyl, octyloxynonyl, decyloxymethyl, decyloxyethyl, decyloxypropyl, decyloxybutyl, decyloxypentyl, decyloxyhexyl, decyloxyheptyl, 1-methylethyl, 1-methylpropyl, 1-methylbutyl, 1-methylpentyl, 1-methylhexyl, 1-methylheptyl, 1-methyloctyl, 1-methylnonyl, 1-methyldecyl, 2-methylpropyl, 2-methylbutyl, 2-bethylpentyl, 2-methylhexyl, 2-methylheptyl, 2-methyloctyl, 2,3,3-trimethylbutyl, 3-methylpentyl, 2,3-dimethylpentyl, 2,4-dimethylpentyl, 2,3,3,4-tetramethylpentyl, 3-methylhexyl, or 2,5-dimethylhexyl. A preferred R¹R² ethylene contributed monomer unit is isobutylene, and a preferred alkyl vinyl ether contributed monomer unit is methyl vinyl ether.

The poly(alkenyl-co-maleimide) is formed by imidizing a poly(alkenyl-co-maleic anhydride) with a mono-primary amine or ammonia at temperatures from about 100° C. to about 300° C. and at a pressure from about slightly above vacuum to about 2026 kPa, under substantially dry conditions. The reactants are preferably dry mixed in the absence of solvents in a suitable mixing apparatus such as a Brabender mixer. Purging the mixer with N₂ prior to charging of the reactants can be preferred. The primary amine or ammonia may be added in a single charge or in sequential partial charges into the reactor containing a charge of poly(alkenyl-co-maleic anhydride). Preferably, the primary amine or ammonia is charged in ratio between about 0.8 to 0.99 moles of nitrogen per monomer contributed units of maleic anhydride in the poly(alkenyl-co-maleic anhydride). The resultant polymer is therefore about 80-99% imidized by the reaction with the primary amine or ammonia.

Suitable primary amines include, but are not limited to alkyl amines, alkyl benzyl amines, alkyl phenyl amines, alkoxybenzyl amines, alkyl aminobenzoates, and alkoxy aniline, containing from 1 to about 50 carbon atoms in the alkyl and alkoxy substituents in the primary amine. The alkyl and alkoxy substituents on the above-discussed primary amines can be linear or branched, preferably linear, and saturated or unsaturated, preferably saturated. Exemplary amines include hexylamine, octylamine, dodecylamine, and the like.

The poly(alkenyl-co-maleimide) preferably has a weight average molecular weight (M_{W}) of between about 10,000 and 500,000, more typically between about 150,000 and 450,000.

The centipede polymer may be prepared by any means known in the art for combining such ingredients, such as blending, milling, or internal batch mixing. The centipede polymers of this invention are preferably manufactured by mixing and dynamically heat treating (e.g. about 50 to 290° C.) the components described above, namely, by melt mixing. As for the mixing equipment, any conventional, generally known equipment such as an open type mixing roll, closed-type Banbury mixer, closed-type Brabender mixer, extruding machine, kneader, continuous mixer, etc., is acceptable. The closed-type Brabender mixer is preferred, as is mixing in an inactive gas environment such as N₂ or Ar.

To form the ionomeric polymer, an inorganic salt is added to the partially imidized centipede polymer. The inorganic salt is added in a ratio of between about 0.01 and 0.2 moles of salt per mole of maleic anhydride/maleimide in the poly(alkenyl-co-maleic anhydride/poly(alkenyl-co-maleimide). The inorganic salt may be added simultaneously to, subsequently to, or prior to the addition of the mono-primary amine or ammonia to the poly(alkenyl-co-maleic anhydride). The inorganic salt reacts with the non-imidized maleic anhydride contributed monomer units. Accordingly, the ionomeric polymer composition includes greater than about 80% imide units, preferably greater than about 90% imide units, and most preferably greater than about 95% imide units; at least about 50%, preferably at least about 75% and more preferably at least about 95% of the non-imidized maleic anhydride contributed monomer units are reacted with the inorganic salt. A preferred method for forming the ionomeric polymer is by mixing the ionomeric salt centipede polymer at elevated temperature, such as above 100° C.

Preferred inorganic salts include cobalt boron neodecanate, and metal salts including the acetate or oxide of Zn, Na, Mg, Ba, B, Co, and Al. The inorganic salts are preferably dry mixed with the centipede polymer and allowed to react with the non-imidized maleic anhydride contributed monomer units. The pendant ionic groups may interact to form ion-rich aggregates in the nonpolar polymer matrix. These interactions are believed to improve the physical characteristics of the polymer composition, such as damping capabilities and mechanical strength.

An extender can be added to the polymer composition during processing to yield a thermoreversible elastomeric composition. After being extended, the polymer composition may be a gel-like material that is elastic, thermally recyclable, and high damping. In addition, it has high mechanical strength.

Suitable extenders include extender oils and low molecular weight compounds or components, such as the extenders including one or more of softening agents, plasticizers, tackifiers, oligomers, lubricants, petroleum hydrocarbons, silicone oil, aromatic oil, naphthenic oil, and paraffinic oils. Preferred extenders include various oils such as paraffinic oils. The final polymer compositions may contain between about 10 and 50% by weight, preferably between about 25 and 40% by weight, extender.

In addition, additives such as stabilizers, antioxidants, reinforcing agents, reinforcing resins, pigments, and fragrances may also be utilized in the present compositions. Specific examples of useful antioxidants and stabilizers include 2-(2′-hydroxy-5′-methylphenyl) benzotriazole, nickel di-butyl-di-thiocarbamate, zinc di-butyl-di-thiocarbamate, tris(nonylphenyl) phosphite, 2,6-di-t-butyl-4-methylphenol, and the like. Exemplary conventional fillers and pigments include silica, carbon black, TiO₂ Fe₂O₃, and the like. These compounding ingredients are incorporated in suitable amounts depending upon the contemplated use of the product, preferably in the range of about 1-350 parts by weight of additives or compounding ingredients per 100 parts of the polymer composition.

A reinforcement may be defined as a material added to a polymer matrix to improve the strength of the polymer composition. Most of these reinforcing materials are inorganic or organic products of high molecular weight. Various examples include glass fibers, asbestos, boron fibers, carbon and graphite fibers, whiskers, quartz and silica fibers, ceramic fibers, metal fibers, natural organic fibers, and synthetic organic fibers. Other elastomers and resins are also useful to enhance specific properties like damping properties, adhesion, and processability. In this case, the foregoing materials are equally applicable to the instant ionomeric centipede polymer compositions.

Damping is the absorption of mechanical energy by a material in contact with the source of that energy. Damping or mitigating the transmission of mechanical energy from, for example, a motor, engine, or power source to its surroundings often is desirable. Elastomeric materials are often used for this purpose. It is desirable that such materials be highly effective in converting this mechanical energy into heat rather than transmitting it to the surroundings. It is further desirable that this damping or conversion is effective over a wide range of temperatures and frequencies commonly found near motors, automobiles, trucks, trains, planes, and the like.

The compositions of the present invention are favorably used in the manufacture of any product in which the following properties are advantageous: a degree of softness, heat resistance, decent mechanical properties, elasticity, good adhesion, and/or high damping. Moreover, the present compositions evidence a compression set (C.S.) at 100° C. of at least less than about 70%, Shore A Hardness of at least less than about 50, more preferably less than about 20, and a tan δ at 25° C. of above about 0.4, more preferably above about 0.6. The compositions of the present invention can be used in, for example, the fabrication of automotive parts, household electrical appliances, industrial machinery, precision instruments, transport machinery, constructions, engineering, medical instruments, and tire rubber formulations.

The composition of the present invention may be used in the fabrication of damping materials and vibration restraining materials. These uses involve connecting materials such as sealing materials, packing, gaskets, and grommets; supporting materials, such as mounts, holders, and insulators; and cushion materials such as stoppers, cushions, and bumpers. These materials are also used in equipment producing vibration or noise and household electrical appliances, such as in air-conditioners, laundry machines, refrigerators, electric fans, vacuums, dryers, printers, and ventilator fans. These materials are also suitable for impact absorbing materials in audio equipment and electronic or electrical equipment, sporting goods, and shoes.

The present invention is described in more detail in the following non-limiting examples. These are presented for purposes of illustration only and are not to be construed in a limiting sense.

### EXAMPLES

### Example 1

To a 6 L kneader extruder (MXE-6, Jaygo, Inc.) equipped with sigma blades was added 1.3 kg ISOBAN-10™ poly(maleic anhydride-alt-isobutylene) (Kuraray Co, LTD, Tokyo, Japan), and 1 kg octylamine (99% purity, BASP) at 80° C. The contents were mixed with a blade speed of 25 rpm and a screw speed of 40 rpm for 5 minutes. The temperature of the mixer was then adjusted to 195° C. at a rate of about 3° C./min. Mixing was continued isothermally at 195° C. for an additional 2 hours. The temperature of the mixer was then adjusted to 160° C. under vacuum. After 30 minutes at those conditions, the final product was extruded through a 1/4 inch (0.64 cm) die. Gel permeation chromatography indicated a M_{W}=242,780 and Mₙ=125,430; polydispersity was calculated at about 1.94. The acid value of the product was 0.516 mg/g using KOH titration in a THF solution.

### Example 2

A charge of 40 g of the product from Example 1 was added to a nitrogen purged Brabender mixer (˜55 g capacity) equipped with a roller blade. The mixer was initially set to 160° C. and 60 rpm. After 3 minutes, a charge of 10 g DTDP oil (Aldrich) was added to the mixer. The material was further mixed at these conditions for 15 minutes. Agitation was stopped and the mixture was removed from the mixer.

### Example 3

A charge of 40 g of the product of Example 1 was charged into a nitrogen purged Brabender mixer (˜55 g capacity). The mixer was initially set to 160° C. and 60 rpm. After 3 minutes, a charge of 10 g DTDP oil was added into the mixer. Mixing was continued for another 5 minutes, then 5 g of 70% cobalt boron neodecanate in paraffin oil (sold under the Manobond C™ by Rhone-Poulenc) was added to the mixer. The material was further mixed at these conditions for 12 minutes. The agitation was then stopped and the mixture was removed from the mixer.

### Examples 4-7

The procedure of Example 3 was repeated with:

Example 4: 35 g of the product of Example 1, 15 g DTDP oil, and 2.5 g cobalt boron neodecanate. The total mixing time was 20 minutes.

Example 5: 40 g of the product of Example 1, 10 g DTDP oil, and 2.0 g cobalt boron neodecanate.

Example 6: 35 g of the product of Example 1, 15 g DTDP oil, and 2.5 g magnesium acetate.

Example 7: 35 g of the product of Example 1, 15 g DTDP oil, and 3.0 g zinc acetate.

The products of examples 2-7 were molded into sheets and cylinder buttons at˜160° C. Ring samples were cut from these sheets for tensile measurements. The details of the physical properties of the final materials are listed in the following table. As can be seen, the products were soft, thermnally recyclable, and high damping.

TABLE 1

| | | C.S. | Tb | Eb | | tan δ |
|---|---|---|---|---|---|---|
| | Additive | (100° C.) | kPa | % | Shore A | (25° C.) |
| 2 | None | Flowing | N/A | N/A | — | — |
| 3 | Manobond | 65.3% | 1598 | 281 | 25 | 0.41 |
| | C | | | | | |
| 4 | Manobond | 77.9% | 2122 | 482 | 22 | 1.20 |
| | C | | | | | |
| 5 | Manobond | 69.0% | 3411 | 397 | 19 | 1.10 |
| | C | | | | | |
| 6 | Mg(Ac)₂ | 67.1% | 303 | 310 | 5 | 2 |
| 7 | Zn(Ac)₂ | 71.4% | 172 | 405 | 2 | 0.65 |

The invention has been described with reference to certain preferred embodiments. Modifications and alterations will occur to others upon reading the preceding, detailed description. The invention is to be construed as including all such modifications and alterations insofar as they come within the scope of the appended claims or the equivalents thereof.

We claim:

1. A polymer composition comprising:
a poly(alkenyl-co-maleimide),
an inorganic salt, and
optionally, an extender.

2. The composition of claim 1 wherein the alkenyl contributed monomer units of said poly(alkenyl-co-maleimide) comprise one or more of vinyl-substituted aromatic hydrocarbons, R¹R² ethylenes, and alkyl vinyl ethers.

3. The composition of claim 2 wherein said vinyl-substituted aromatic hydrocarbon is chosen from any one or combination of styrene, α-methylstyrene, 1-vinylnaphthalene, 2-vinylnaphthalene, 1-α-methylvinylnaphthalene, 2-α-methylvinylnaphthalene, as well as alkyl, cycloalkyl, aryl, alkaryl, and aralkyl derivatives thereof, as well as di- or tri-vinyl-substituted aromatic hydrocarbons.

4. The composition of claim 2 wherein the R¹ and R² of said R¹R² ethylene contributed monomer units and the alkyl of said alkyl vinyl ether contributed monomer units are independently selected from methyl, ethyl, propyl, isopropyl, butyl, isobutyl, pentyl, isopentyl, hexyl, heptyl, octyl, nonyl, decyl, undecyl, dodecyl, tredecyl, tetradecyl, pentadecyl, hexadecyl, heptadecyl, octadecyl, nonadecyl, eicosyl, cyclopropyl, 2,2-demethylcyclopropyl, cyclopentyl, cyclohexyl, methoxymethyl, methoxyethyl, methoxypropyl, methoxybutyl, methoxypentyl, methoxyhexyl, methoxyoctyl, methoxynonyl, ethoxydecyl, ethoxymethyl, ethoxyethyl, ethoxypropyl, ethoxybytyl, ethoxypentyl, ethoxyhexyl, ethoxyheptyl, ethoxyoctyl, ethoxynonyl, ethoxydecyl, propoxymethyl, propoxyethyl, propoxypropyl, propoxybutyl, propoxypentyl, propoxyheptyl, propoxyoctyl, propoxynonyl, propoxydecyl, butoxymethyl, butoxyethyl, butoxypropoyl, butoxybutyl, butoxypentyl, butoxyhexyl, butoxyheptyl, butoxyoctyl, butoxynonyl, butoxydecyl, pentyloxymethyl, pentyloxyethyl, pentyloxypropyl, pentyloxybutyl, pentyloxypentyl, pentyloxyhexyl, pentyloxyoctyl, pentyloxynonyl, pentyloxydecyl, hexyloxymethyl, hexyloxyethyl, hexyloxypropyl, hexyloxybutyl, hexyloxypentyl, hexyloxyhexyl, hexyloxyheptyl, hexyloxyoctyl, hexyloxynonyl, hexyloxydecyl, heptyloxymethyl, heptyloxyethyl, heptyloxypropyl, heptyloxybutyl, hexyloxypentyl, heptyloxyhexyl, heptyloxyheptyl, heptyloxyoctyl, heptyloxynonyl, heptyloxydecyl, octyloxymethyl, octyloxyethyl, octyloxypropyl, octyloxybutyl, octyloxypentyl, octyloxyhexyl, octyloxyheptyl, octyloxyoctyl, octyloxynonyl, decyloxymethyl, decyloxyethyl, decyloxypropyl, decyloxybutyl, decyloxypentyl, decyloxyhexyl, decyloxyheptyl, 1-methylethyl, 1-methylpropyl, 1-methylbutyl, 1-methylpentyl, 1-methylhexyl, 1-methylheptyl, 1-methyloctyl, 1-methylnonyl, 1-methyldecyl, 2-methylpropyl, 2-methylbutyl, 2-bethylpentyl, 2-methylhexyl, 2-methylheptyl, 2-methyloctyl, 2,3,3-trimethylbutyl, 3-methylpentyl, 2,3-dimethylpentyl, 2,4-dimethylpentyl, 2,3,3,4-tetramethylpentyl, 3-methylhexyl, or 2,5-dimethylhexyl.

5. The composition of claim 1 wherein the maleimide contributed monomer units of said poly(alkenyl-co-maleimide) are the reaction product of a maleic anhydride and a mono-primary amine or ammonia.

6. The composition of claim 5 wherein said primary amine is one or more of alkyl amines, alkyl benzyl amines, alkyl phenyl amines, alkoxybenzyl amines, alkyl aminobenzoates, and alkoxy aniline, containing from 1 to about 50 carbon atoms in the alkyl and alkoxy substituents in the primary amine.

7. The composition of claim 1 wherein at least about 5% of the maleimide contributed monomer units of said poly(alkenyl-co-maleimide) are present as maleic anhydride.

8. The composition of claim 7 wherein said poly(alkenyl-co-maleimide) includes non-imidized maleic anhydride monomer units and said inorganic salt forms an ionomer with non-imidized maleic anhydride monomer units.

9. The composition of claim 1 wherein said inorganic salt is chosen from one or more of cobalt boron neodecanate and metal salts including the acetate or oxide of Zn, Na, Mg, Ba, B, Co, and Al.

10. The composition of claim 1 wherein said extender is one or more of softening agents, plasticizers, tackifiers, oligomers, lubricants, petroleum hydrocarbons, silicone oil, aromatic oil, naphthenic oil, and paraffinic oil.

11. The composition of claim 1 comprising between about 10 and 50% by weight extender.

12. A process for forming an ionomeric polymer composition comprising mixing together at least one poly(alkenyl-co-maleimide), at least one inorganic salt, and optionally, an extender.

13. The process of claim 12 wherein the alkenyl contributed monomer units of said poly(alkenyl-co-maleimide) are one or more of vinyl-substituted aromatic hydrocarbons, R¹R² ethylenes, and alkyl vinyl ethers.

14. The process of claim 12 wherein the maleimide contributed monomer units of said poly(alkenyl-co-maleimide) are the reaction product of a maleic anhydride and a primary amine or ammonia.

15. The process of claim 12 wherein said poly(alkenyl-co-maleimide) includes non-imidized maleic anhydride monomer units and said at least one inorganic salt reacts with the non-imidized maleic anhydride monomer units to form said ionomeric polymer composition.

16. The process of claim 12 wherein said inorganic salt is present in an amount of between 0.01 and 0.2 moles per mole of maleimide and maleic anhydride units.

17. The process of claim 12 wherein said at least one inorganic salt is one or more of cobalt boron neodecanate, and metal salts including the acetate or oxide of Zn, Na, Mg, Ba, B, Co, and Al.

18. The process of claim 12 wherein said extender is one or more of softening agents, plasticizers, tackifiers, oligomers, lubricants, petroleum hydrocarbons, silicone oil, aromatic oil, naphthenic oil, and paraffinic oil.

19. The process of claim 12 including between about 10 and 50% by weight extender.

20. A polymeric composition comprising an extended centipede polymer, said centipede polymer substantially comprising alkenyl units, maleimide units of maleic anhydride and primary amine or ammonia, and a minority of ionomeric units of maleic anhydride and ionic salt, said polymeric composition having a tan δ of above about 0.4 at 25° C.
